(19) United States
(12) Patent Application Publication
(10) Pub. No.: US 2026/0184313 A1
(43) Pub. Date: Jul. 2, 2026

(54) Development and Transfer of a Driver Behavior Profile for Vehicle Mode Optimization

(71) Applicant: Nissan North America, Inc., Franklin, TN (US)

(72) Inventors: Corey Heath, Scottsdale, AZ (US); Mark Bailey, Seattle, WA (US); Erik Lee St. Gray, Tacoma, WA (US); Atsushi Kasuya, Los Altos Hills, CA (US); Shilpi Soni, Santa Clara, CA (US); Stefan Witwicki, San Carlos, CA (US); Marcell Jose Vazquez-Chanlatte, Los Altos, CA (US)

(21) Appl. No.: 19/003,610

(22) Filed: Dec. 27, 2024

(51) Int. Cl. B60W 30/182; B60W 40/09; B60W 50/00

(52) U.S. Cl. CPC B60W 30/182; B60W 40/09; B60W 50/00; B60W 2050/0083; B60W 2556/45

(57) ABSTRACT

A method includes obtaining a user profile that includes first parameter values associated with a first powertrain control mode and lacks second parameter values associated with a second powertrain control mode. The method also includes identifying a behavior group based on similarity of the user profile to third-party profiles in the behavior group, and updating the user profile based on the third-party profiles to include the second parameter values. The method also includes controlling a vehicle powertrain based on the user profile.

### TECHNICAL FIELD

This disclosure relates generally to battery electric vehicles, and development and transfer of a driver behavior profile for vehicle mode optimization.

### BACKGROUND

A battery electric vehicle (BEV) typically includes an electric motor (powered by an electric battery) to move the vehicle. Additionally, energy recaptured via regenerative braking can be used to recharge the battery. A consideration in the operation of BEVs is the ability to switch between operating modes. As an example, operating modes may control powertrain operation, such as by provision of one or more modes that optimize battery efficiency, by provision of one or more modes that optimize performance, and/or by provision of other types of modes. Sub-optimal use of operating modes may result in, for example, inefficient use of the electric battery or selection of performance characteristics that are not well-suited for the environmental conditions under which the BEV is operating.

### SUMMARY

A first aspect of the disclosed implementations is a method. The method includes obtaining a user profile that includes first parameter values associated with a first powertrain control mode and lacks second parameter values associated with a second powertrain control mode. The method also includes identifying a behavior group based on similarity of the user profile to third-party profiles in the behavior group, and updating the user profile based on the third-party profiles to include the second parameter values. The method also includes controlling a vehicle powertrain based on the user profile.

A second aspect of the disclosed embodiments is an apparatus. The apparatus includes a memory subsystem and one or more processors. The one or more processors are configured to execute instructions stored in the memory subsystem to obtain a user profile that includes first parameter values associated with a first powertrain control mode and lacks second parameter values associated with a second powertrain control mode, identify a behavior group +based on similarity of the user profile to third-party profiles in the behavior group, update the user profile based on the third-party profiles to include the second parameter values, and control a vehicle powertrain based on the user profile.

A third aspect of the disclosed embodiments is a non-transitory computer-readable storage medium storing instructions operable to cause one or more processors to perform operations. The operations comprise obtaining a user profile that includes first parameter values associated with a first powertrain control mode and lacks second parameter values associated with a second powertrain control mode. The operations further comprise identifying a behavior group based on similarity of the user profile to third-party profiles in the behavior group, and updating the user profile based on the third-party profiles to include the second parameter values. The operations further comprise controlling a vehicle powertrain based on the user profile.

Variations in these and other aspects, features, elements, implementations, and embodiments of the methods, apparatus, procedures, and algorithms disclosed herein are described in further detail hereafter.

### BRIEF DESCRIPTION OF THE DRAWINGS

The various aspects of the methods and apparatuses disclosed herein will become more apparent by referring to the examples provided in the following description and drawings in which like reference numbers refer to like elements.

FIG. 1 is a diagram of an example of a vehicle.

FIG. 2 is a diagram of an example of a portion of a vehicle transportation and communication system.

FIG. 3 is a diagram of a powertrain for a battery electric vehicle, including a control module.

FIG. 4A is a diagram of a planner that is implemented by the control module of FIG. 3.

FIGS. 4B-4C are graphs that illustrate relationships between an accelerator pedal state and a resulting motor output.

FIG. 5A is an illustration of an example of operation of the vehicle.

FIG. 5B is an illustration of an example of operation of the vehicle.

FIG. 6 is a block diagram of a classification system.

FIG. 7A is an illustration of a process for creating, updating, and classifying the user profile.

FIG. 7B is an illustration of a process for transferring the user profile to a new vehicle.

FIG. 8 is a diagram of an example of a process for determination of a powertrain control decision.

FIG. 9 is a diagram of an example of a process for obtaining the user profile.

FIG. 10 is a diagram of an example of a process for identifying one of the behavior groups for the user profile.

### DETAILED DESCRIPTION

As mentioned above, a battery electric vehicle (BEV) typically includes an electric battery. A BEV may include an intelligent powertrain system that controls vehicle mode and powertrain optimizations for the BEV. The intelligent powertrain system may control the vehicle mode and powertrain optimizations based on vehicle state information (e.g., determined by sensors), environment information, route information, navigation map information, user profile information, and/or other information. The terms “drive mode,” “driving mode,” “IPT mode,” and “powertrain mode” may be used interchangeably herein to include both a vehicle mode and powertrain optimizations.

Some examples of drive modes known in the art, and which may be referred to by various de facto and/or trade names, include “eco mode” (economizes fuel consumption or stored battery energy while driving); “sport mode” (provides more responsive throttle, increased power availability, stiffer suspension, and/or firmer steering); “snow mode” (alters a vehicle's driving dynamics to achieve better control and grip on a driving surface); “off-road mode” (maximizes a vehicle's traction); “4-wheel drive (4WD) mode,” “2-wheel drive (2WD) mode,” “all-wheel drive (AWD) mode,” and “front-wheel drive (FWD) mode” (provides certain wheels of a vehicle with certain power at specific times and/or under specific conditions); “cruise mode” or “cruise control” (maintains constant vehicle speed); “engine on/off mode” (turns on an engine of a vehicle to charge a battery of the vehicle or turns off the engine such that the vehicle is thereafter propelled by power from the battery); “e-pedal mode” (controls acceleration, deceleration, and stopping using a single pedal of a vehicle); “low regenerative braking mode” (e.g., Nissan's “D mode,” which provides standard or balanced driving performance); and “high regenerative braking mode” (e.g., Nissan's “B mode,” which provides increased regenerative braking).

Described herein are systems and techniques for controlling vehicle systems, inclusive of an IPT system, using user profile information. User profile information may be obtained by recording user profile information while the BEV is being driven. However, a user profile may include incomplete information with respect to use of certain modes, with respect to driver preferences under certain environmental conditions, or due to other circumstances. To address this issue, values for some parameters of a user profile may be inferred based on the preferences of other drivers who have preferences that are similar to that of the subject driver. To do this, a large number of user profiles may be analyzed to cluster drivers into groups according to similar preferences based on their respective user profiles. When a parameter needs to be inferred for a particular user, the parameter may be determined using information from the user profiles of other drivers in the same group. This approach can be employed within a single vehicle, for example, to control a mode switch to a mode that has not previously been used by the current driver or to control a mode switch when environmental conditions differ from previously experienced environmental conditions. This approach can also be employed when the driver uses a new vehicle for the first time. In this situation, the user profile for the driver may be obtained from a data source that is separate from the vehicle (e.g., a server or a personal device associated with the user).

Further details of intelligent powertrain control are described herein with initial reference to an environment in which the systems and techniques can be implemented.

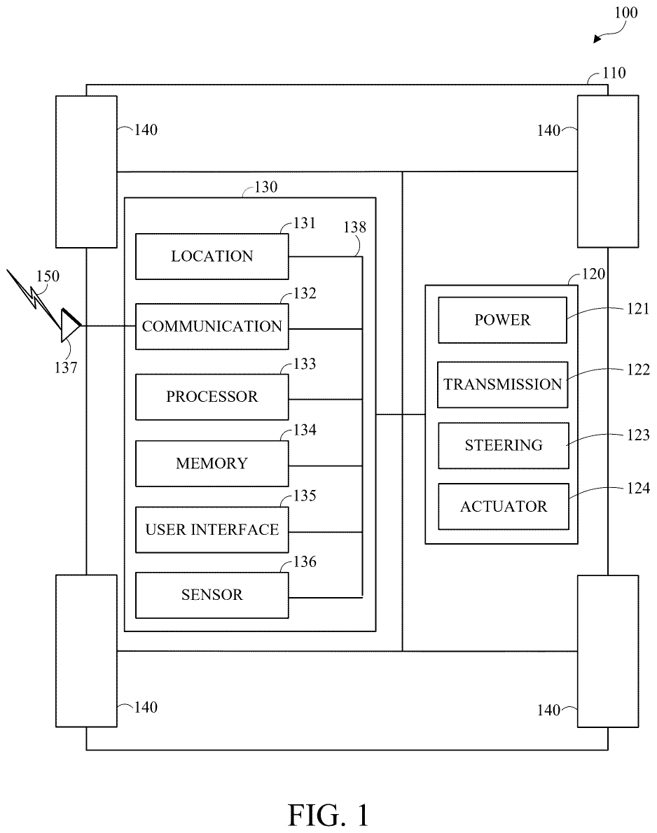

FIG. 1 is a diagram of an example of a vehicle 100 in which the aspects, features, and elements disclosed herein may be implemented. In the embodiment shown, the vehicle 100 includes various vehicle systems, such as a chassis 110, a powertrain 120, a controller 130, and wheels 140. Additional or different combinations of vehicle systems may be used. Although the vehicle 100 is shown as including four wheels 140 for simplicity, other mechanical configurations, such as a propeller or a tread, may be used. In FIG. 1, the lines interconnecting elements, such as the powertrain 120, the controller 130, and the wheels 140, indicate that information, such as data or control signals, power, such as electrical power or torque, or both information and power, may be communicated between the respective elements. For example, the controller 130 may receive power from the powertrain 120 and may communicate with the powertrain 120, the wheels 140, or both, to control the vehicle 100, which may include accelerating, decelerating, steering, or otherwise controlling the vehicle 100.

The powertrain 120 shown by example in FIG. 1 includes a power source 121, a transmission 122, a steering unit 123, and an actuator 124. Any other element or combination of elements of a powertrain, such as a suspension, a drive shaft, axles, or an exhaust system may also be included. Although shown separately, the wheels 140 may be included in the powertrain 120.

The power source 121 includes an engine, a battery, or a combination thereof. The power source 121 may be any device or combination of devices operative to provide energy, such as electrical energy, thermal energy, or kinetic energy. In an example, the power source 121 includes an engine, such as an internal combustion engine, an electric motor, or a combination of an internal combustion engine and an electric motor and is operative to provide kinetic energy as a motive force to one or more of the wheels 140. Alternatively, or additionally, the power source 121 includes a potential energy unit, such as one or more dry cell batteries, such as nickel-cadmium (NiCd), nickel-zinc (NiZn), nickel metal hydride (NiMH), lithium-ion (Li-ion); solar cells; fuel cells; or any other device capable of providing energy.

The transmission 122 receives energy, such as kinetic energy, from the power source 121, transmits the energy to the wheels 140 to provide a motive force. The transmission 122 may be controlled by the controller 130, the actuator 124, or both. The steering unit 123 may be controlled by the controller 130, the actuator 124, or both and control the wheels 140 to steer the vehicle. The actuator 124 may receive signals from the controller 130 and actuate or control the power source 121, the transmission 122, the steering unit 123, or a combination thereof to operate the vehicle 100.

In the illustrated embodiment, the controller 130 includes a location unit 131, an electronic communication unit 132, a processor 133, a memory 134, a user interface 135, a sensor 136, and an electronic communication interface 137. Fewer of these elements may exist as part of the controller 130. Although shown as a single unit, any one or more elements of the controller 130 may be integrated into any number of separate physical units. For example, the user interface 135 and the processor 133 may be integrated in a first physical unit and the memory 134 may be integrated in a second physical unit. Although not shown in FIG. 1, the controller 130 may include a power source, such as a battery. Although shown as separate elements, the location unit 131, the electronic communication unit 132, the processor 133, the memory 134, the user interface 135, the sensor 136, the electronic communication interface 137, or a combination thereof may be integrated in one or more electronic units, circuits, or chips.

The processor 133 may include any device or combination of devices capable of manipulating or processing a signal or other information now existing or hereafter developed, including optical processors, quantum processors, molecular processors, or a combination thereof. For example, the processor 133 may include one or more special purpose processors, one or more digital signal processors, one or more microprocessors, one or more controllers, one or more microcontrollers, one or more integrated circuits, one or more Application Specific Integrated Circuits, one or more Field Programmable Gate Array, one or more programmable logic arrays, one or more programmable logic controllers, one or more state machines, or a combination thereof. The processor 133 is operatively coupled with one or more of the location unit 131, the memory 134, the electronic communication interface 137, the electronic communication unit 132, the user interface 135, the sensor 136, and the powertrain 120. For example, the processor may be operatively coupled with the memory 134 via a communication bus 138.

The memory 134 includes any tangible non-transitory computer-usable or computer-readable medium, capable of, for example, containing, storing, communicating, or transporting machine readable instructions, or any information associated therewith, for use by or in connection with any processor, such as the processor 133. The memory 134 may be, for example, one or more solid state drives, one or more memory cards, one or more removable media, one or more read-only memories, one or more random access memories, one or more disks, including a hard disk, a floppy disk, an optical disk, a magnetic or optical card, or any type of non-transitory media suitable for storing electronic information, or a combination thereof. For example, a memory may be one or more read only memories (ROM), one or more random access memories (RAM), one or more registers, low power double data rate (LPDDR) memories, one or more cache memories, one or more semiconductor memory devices, one or more magnetic media, one or more optical media, one or more magneto-optical media, or a combination thereof.

The electronic communication interface 137 may be a wireless antenna, as shown, a wired communication port, an optical communication port, or any other wired or wireless unit capable of interfacing with a wired or wireless electronic communication medium 150. Although FIG. 1 shows the electronic communication interface 137 communicating via a single communication link, a communication interface may be configured to communicate via multiple communication links. Although FIG. 1 shows a single instance of the electronic communication interface 137, the vehicle 100 may include any number of communication interfaces.

The electronic communication unit 132 is configured to transmit or receive signals via a wired or wireless electronic communication medium 150, such as via the electronic communication interface 137. Although not explicitly shown in FIG. 1, the electronic communication unit 132 may be configured to transmit, receive, or both via any wired or wireless communication medium, such as radio frequency (RF), ultraviolet (UV), visible light, fiber optic, wireline, or a combination thereof. Although FIG. 1 shows a single instance of the electronic communication unit 132 and a single instance of the electronic communication interface 137, any number of electronic communication units and any number of electronic communication interfaces may be used. In some embodiments, the electronic communication unit 132 includes a dedicated short-range communications (DSRC) unit, an on-board unit (OBU), or a combination thereof.

The location unit 131 may determine geolocation information, such as longitude, latitude, elevation, direction of travel, or speed, of the vehicle 100. For example, the location unit includes a global navigation satellite system (GNSS) unit (e.g., a global positioning system (GPS) unit), a wide area augmentation system (WAAS) enabled National Marine-Electronics Association (NMEA) unit, a radio triangulation unit, or a combination thereof. The location unit 131 can be used to obtain information that represents, for example, a current heading of the vehicle 100, a current position of the vehicle 100 in two or three dimensions, a current angular orientation of the vehicle 100, or a combination thereof.

The user interface 135 includes any unit capable of interfacing with a person, such as a virtual or physical keypad, a touchpad, a display, a touch display, a heads-up display, a virtual display, an augmented reality display, a haptic display, a feature tracking device, such as an eye-tracking device, a speaker, a microphone, a video camera, a sensor, a printer, or a combination thereof. The user interface 135 may be operatively coupled with the processor 133, as shown, or with any other element of the controller 130. Although shown as a single unit, the user interface 135 may include one or more physical units. For example, the user interface 135 may include both an audio interface for performing audio communication with a person and a touch display for performing visual and touch-based communication with the person. The user interface 135 may include multiple displays, such as multiple physically separate units, multiple defined portions within a single physical unit, or a combination thereof.

The sensor 136 is operable to provide information that may be used to control the vehicle. The sensor 136 may include multiple sensors or an array of sensors. The sensor 136 may provide information regarding current operating characteristics of the vehicle 100, including vehicle operational information. The sensor 136 can include, for example, a speed sensor, acceleration sensors, a steering angle sensor, traction-related sensors, braking-related sensors, steering wheel position sensors, eye tracking sensors, seating position sensors, or any sensor, or combination of sensors, which are operable to report information regarding some aspect of the current dynamic situation of the vehicle 100.

The sensor 136 may include one or more sensors that are operable to obtain information regarding the physical environment surrounding the vehicle 100, such as operational environment information. For example, one or more sensors may detect road geometry, such as lane lines, and obstacles, such as fixed obstacles, vehicles, and pedestrians. The sensor 136 can be or include one or more video cameras, laser-sensing systems, infrared-sensing systems, acoustic-sensing systems, or any other suitable type of on-vehicle environmental sensing device, or combination of devices, now known or later developed. In some embodiments, the sensor 136 and the location unit 131 are combined.

Although not shown separately, the vehicle 100 may include a trajectory controller. For example, the controller 130 may include the trajectory controller. The trajectory controller may be operable to obtain information describing a current state of the vehicle 100 and a route planned for the vehicle 100, and, based on this information, to determine and optimize a trajectory for the vehicle 100. In some embodiments, the trajectory controller may output signals operable to control the vehicle 100 such that the vehicle 100 follows the trajectory that is determined by the trajectory controller. For example, the output of the trajectory controller can be an optimized trajectory that may be supplied to the powertrain 120, the wheels 140, or both. In some embodiments, the optimized trajectory can be or include one or more control inputs such as a set of steering angles, with each steering angle corresponding to a point in time or a position. In some embodiments, the optimized trajectory can be one or more paths, lines, curves, or a combination thereof.

One or more of the wheels 140 may be a steered wheel that is pivoted to a steering angle under control of the steering unit 123, a propelled wheel that is torqued to propel the vehicle 100 under control of the transmission 122, or a steered and propelled wheel that may steer and propel the vehicle 100.

Although not shown in FIG. 1, the vehicle 100 may include additional units or elements not shown in FIG. 1, such as an enclosure, a Bluetooth® module, a frequency modulated (FM) radio unit, a Near Field Communication (NFC) module, a liquid crystal display (LCD) display unit, an organic light-emitting diode (OLED) display unit, a speaker, or a combination thereof.

The vehicle 100 may be an autonomous vehicle that is controlled autonomously, without direct human intervention, to traverse a portion of a vehicle transportation network. Although not shown separately in FIG. 1, an autonomous vehicle may include an autonomous vehicle control unit that performs autonomous vehicle routing, navigation, and control. The autonomous vehicle control unit may be integrated with another unit of the vehicle. For example, the controller 130 may include the autonomous vehicle control unit.

When present, the autonomous vehicle control unit may control or operate the vehicle 100 to traverse a portion of the vehicle transportation network in accordance with current vehicle operation parameters. The autonomous vehicle control unit may control or operate the vehicle 100 to perform a defined operation or maneuver, such as parking the vehicle. The autonomous vehicle control unit may generate a route of travel from an origin, such as a current location of the vehicle 100, to a destination based on vehicle information, environment information, vehicle transportation network information representing the vehicle transportation network, or a combination thereof, and may control or operate the vehicle 100 to traverse the vehicle transportation network in accordance with the route. For example, the autonomous vehicle control unit may output the route of travel to the trajectory controller to operate the vehicle 100 to travel from the origin to the destination using the generated route.

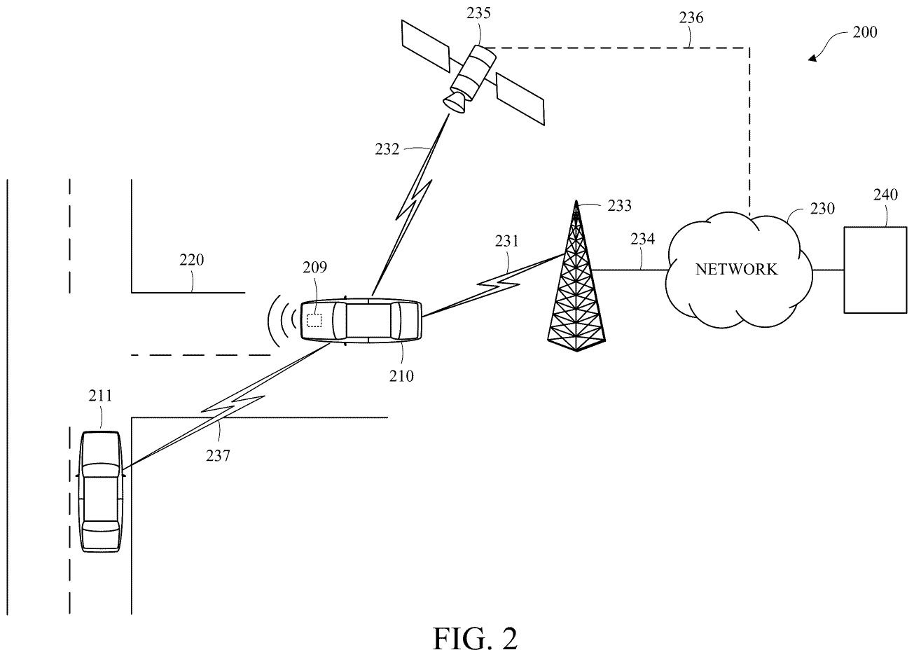

FIG. 2 is a diagram of an example of a portion of a vehicle transportation and communication system 200 in which the aspects, features, and elements disclosed herein may be implemented. The vehicle transportation and communication system 200 may include one or more vehicles, such as a host vehicle 210, and remote vehicle 211, and/or other vehicles. The host vehicle 210 and the remote vehicle 211 may be implemented according to the description of the vehicle 100 of FIG. 1.

The host vehicle 210 and the remote vehicle 211 are configured to travel via one or more portions of the vehicle transportation network 220. The portions of the vehicle transportation network that are traversed by the host vehicle 210 and the remote vehicle 211 may include public roadways such as non-limited access roadways and limited access roadways. Although not explicitly shown in FIG. 2, the host vehicle 210, the remote vehicle 211, and/or other vehicles may traverse an off-road area.

The host vehicle 210 and the remote vehicle 211 are also configured to communicate with each other. Communications between the host vehicle 210 and the remote vehicle 211 may be established via a wired communication link, a wireless communication link, or a combination any number of wired or wireless communication links. As shown, the host vehicle 210 and the remote vehicle 211 communicate via a terrestrial wireless communication link 231, via a non-terrestrial wireless communication link 232, via a direct communication link 237, or via a combination thereof.

The communications between the host vehicle 210, the remote vehicle 211, and/or other devices and systems may be facilitated by an electronic communication network 230. The electronic communication network 230 may be, for example, a multiple access system that provides for communication, such as voice communication, data communication, video communication, messaging communication, or a combination thereof, between the host vehicle 210 or the remote vehicle 211 and a communication device 240 (e.g., one or more communication devices). The communication device 240 may be servers, infrastructure-based sensors, or other computer-implemented systems that are configured to provide information to the host vehicle 210 or the remote vehicle 211. For example, the host vehicle 210 or the remote vehicle 211 may receive information, such as information representing the vehicle transportation network 220, from the communication device 240 via the electronic communication network 230.

The electronic communication network 230 is any type of network configured to provide for voice communication, data communication, or any other type of electronic communication. For example, the electronic communication network 230 may include a local area network (LAN), a wide area network (WAN), a virtual private network (VPN), a mobile or cellular telephone network, the Internet, or any other electronic communication system. The electronic communication network 230 uses a communication protocol, such as the transmission control protocol (TCP), the user datagram protocol (UDP), the internet protocol (IP), the real-time transport protocol (RTP) the HyperText Transport Protocol (HTTP), or a combination thereof. Although shown as a single unit here, an electronic communication network may include any number of interconnected elements.

The terrestrial wireless communication link 231 is a wireless communication channel established between a vehicle, such as the host vehicle 210 or the remote vehicle 211, and an access point 233. The terrestrial wireless communication link 231 may include an Ethernet link, a serial link, a Bluetooth link, an infrared (IR) link, an ultraviolet (UV) link, or any link capable of providing for electronic communication. The access point 233 is a terrestrial structure, such as a radio frequency band antenna, and may include a computing device. The access point 233 is configured to communicate with the host vehicle 210, the electronic communication network 230, and/or the communication device 240 using the terrestrial wireless communication link 231, a wired communication link 234, or a combination thereof. For example, the access point 233 may be a base station, a base transceiver station (BTS), a Node-B, an enhanced Node-B (eNode-B), a Home Node-B (HNode-B), a wireless router, a wired router, a hub, a relay, a switch, or any similar wired or wireless device. Although shown as a single unit here, the access point 233 may include any number of interconnected elements.

The non-terrestrial wireless communication link 232 is a wireless communication channel established between the host vehicle 210 or the remote vehicle 211 and a non-terrestrial communication device, such as a satellite 235. The satellite 235, which may include a computing device, is configured to communicate with the host vehicle 210, with the remote vehicle 211, with the electronic communication network 230, with the communication device 240, or with a combination thereof via one or more communication links such as the non-terrestrial wireless communication link 232 or a communication link 236 between the satellite 235 and the electronic communication network 230. Although shown as a single unit here, the satellite 235 may include any number of interconnected elements.

Communications between the host vehicle 210 and the remote vehicle 211 may include one or more automated inter-vehicle messages, such as a basic safety message (BSM). For example, an automated inter-vehicle message may be transmitted by the remote vehicle 211 and received by the host vehicle 210. The automated inter-vehicle message may be transmitted and received via the electronic communication network 230 using the terrestrial wireless communication link 231 or the non-terrestrial wireless communication link 232. Alternatively, or in addition, the automated inter-vehicle message may be transmitted and received via the direct communication link 237. For example, the remote vehicle 211 may broadcast the message to other vehicles (including the host vehicle 210) within a defined broadcast range, such as 300 meters. In some embodiments, the host vehicle 210 may receive a message via a third party, such as a signal repeater (not shown) or another remote vehicle (not shown). A vehicle such as the host vehicle 210 or the remote vehicle 211 may transmit one or more automated inter-vehicle messages periodically, based on, for example, a defined interval, such as 100 milliseconds.

Automated inter-vehicle messages may include vehicle identification information, geospatial state information, such as longitude, latitude, or elevation information, geospatial location accuracy information, and kinematic state information. Kinematic state information may include vehicle acceleration information, yaw rate information, speed information, vehicle heading information, braking system status information, throttle information, and steering wheel angle information The automated inter-vehicle messages may also include vehicle routing information, or vehicle operating state information, such as vehicle size information, headlight state information, turn signal information, wiper status information, transmission information, or any other information, or combination of information, relevant to the transmitting vehicle state. For example, transmission state information may indicate whether the transmission of the transmitting vehicle is in a neutral state, a parked state, a forward state, or a reverse state.

The host vehicle 210 may identify a portion of the vehicle transportation network 220 or a condition of the vehicle transportation network 220. For example, the vehicle includes an on-vehicle sensor 209 (e.g., one or more on-vehicle sensors) that may be implemented in the manner described with respect to the sensor 136 of FIG. 1. As examples, the on-vehicle sensor 209 may be or include a speed sensor, a wheel speed sensor, a camera, a gyroscope, an optical sensor, a laser sensor, a radar sensor, a sonic sensor, or any other sensor or device or combination thereof capable of determining or identifying a portion or condition of the vehicle transportation network 220.

The host vehicle 210 may traverse a portion or portions of the vehicle transportation network 220 using information communicated via the electronic communication network 230, such as information representing the vehicle transportation network 220, information identified by the on-vehicle sensor 209, or a combination thereof.

Although FIG. 2 shows one instance of the vehicle transportation network 220, one instance of the electronic communication network 230, and one instance of the communication device 240 for simplicity, any number of networks or communication devices may be used. The vehicle transportation and communication system 200 may include devices, units, or elements not shown in FIG. 2. Although the host vehicle 210 is shown as a single unit, a vehicle may include any number of interconnected elements.

Although the host vehicle 210 is shown communicating with the communication device 240 via the electronic communication network 230, the host vehicle 210 may communicate with the communication device 240 via any number of direct or indirect communication links. For example, the host vehicle 210 may communicate with the communication device 240 via a direct communication link, such as a Bluetooth communication link.

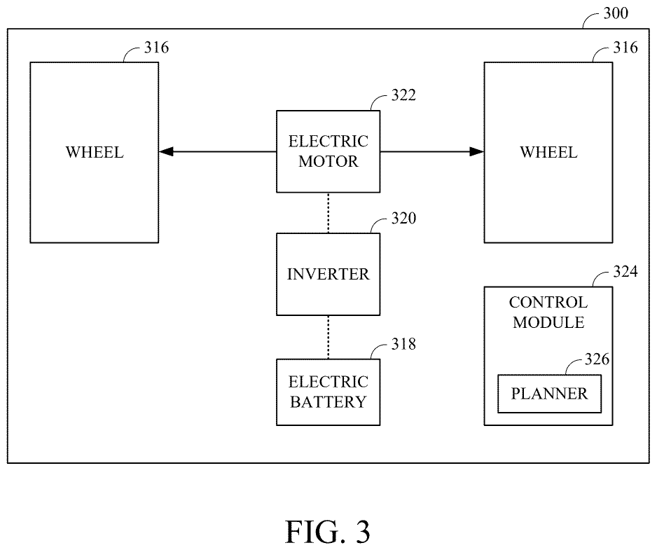

FIG. 3 is a diagram of a powertrain 300 for a BEV in which the aspects, features, and elements disclosed herein may be implemented. Implementations of powertrain control planning according to implementations of this disclosure can be implemented in BEV systems including those described with respect to FIG. 3. In some implementations, the powertrain 300 may be incorporated in the vehicle 100 of FIG. 1 or used in conjunction with some or all of the components thereof.

In the powertrain 300, wheels 316 are driven by the electric motor 322, either directly or through a gearbox (not shown). The electric motor 322 transforms electric energy stored in an electric battery 318 into mechanical energy to drive the wheels 316. The electric battery 318 can be a lightweight, compact, high-performance battery, such as a lithium-ion battery. The electric motor 322 obtains its power from the electric battery 318 via an inverter 320. The electric battery 318 stores electric energy and supplies the energy to the motor as needed. The inverter 320 is a bidirectional power converter that is configured to convert direct-current (DC) power to alternating-current (AC) and to convert AC power to DC power. The inverter 320 converts DC power stored in the electric battery 318 to AC power and supplies the resultant AC power to the electric motor 322, which then drives the wheels 316. During deceleration, AC power is generated by the electric motor 322 (which is configured as a motor-generator) through regenerative braking. The 320 inverter converts the AC power generated through regenerative braking into DC power and stores the DC power in the electric battery 318. can be captured and stored in the electric battery 318 via regenerative braking.

A control module 324 controls the operation of the vehicle. The control module 324 can be or include a processor, such as the processor 133 of FIG. 1. A powertrain control planner according to implementations of this disclosure, such as a planner 326, can be stored in a memory, such as the memory 134 of FIG. 1. Alternatively, the control module 324 can be implemented using specialized hardware or firmware. The control module 324 can execute the planner 326 in order to determine how to control the powertrain 300 of the vehicle 100. As an example, the planner 326 may be provided to the control module 324 in the form of executable instructions that, when executed, cause operation of the planner 326 as will be described herein.

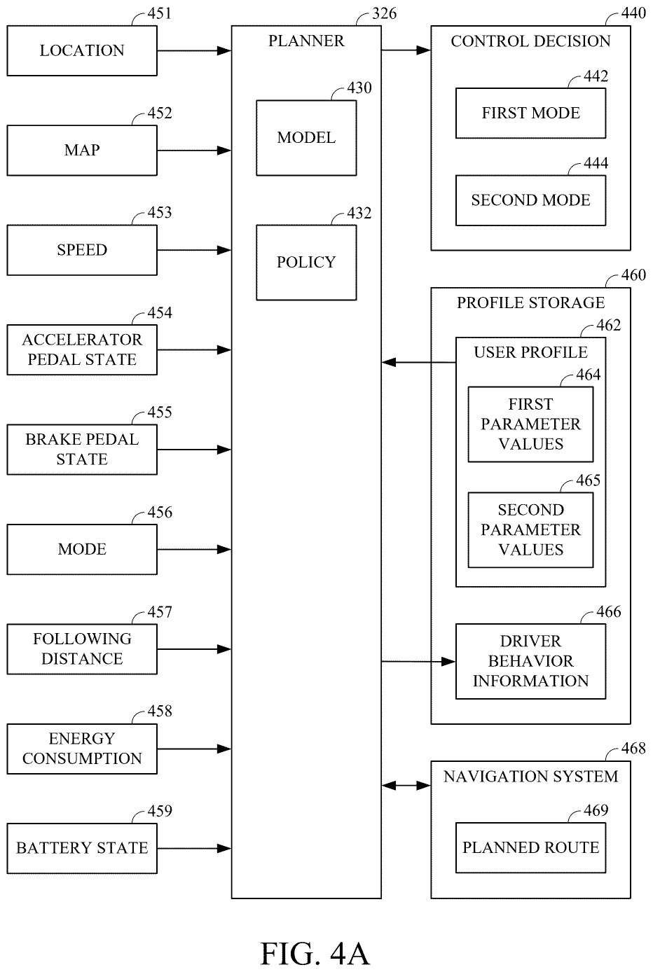

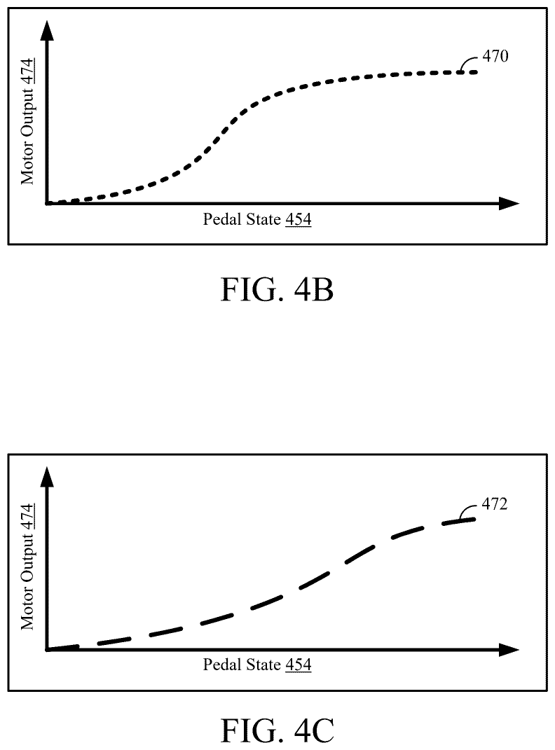

FIG. 4 is a diagram of the planner 326 that is implemented by the control module 324. The planner 326 includes a model 430 (e.g., a decision-making model) that is configured to generate a powertrain control policy, such as a policy 432. The policy 432 is a solution or group of solutions to the model 430 that indicates the next action to be taken for a given state. Using the model 430 and the inputs received by the planner 326, policy 432 may be determined (e.g., computed, calculated, etc.) online or offline. In the online case, the policy 432 is computed dynamically and can reflect/incorporate changes that are occurring in real or near real time as the vehicle 100 traverses portions of the vehicle transportation network 220, which correspond to portions of a navigation map utilized by the planner 326, as will be described. In another example, the policy 432 may be calculated offline and used online (e.g., during actual drives of the vehicle 100). When computed offline, the policy 432 is computed once (e.g., prior to a drive), whereas an online-computed policy can be continually recomputed as the vehicle 100 is being driven. To compute the policy 432, as described above, vehicle parameters and the navigation map 452 are used. In the online case, the vehicle parameters and the navigation map 452 may be static. The vehicle parameters may include the inputs to the planner 326 that were described with respect to FIG. 4.

Using the model 430 and the policy 432, the planner 326 is configured to determine a powertrain control decision, such as a control decision 440 that can be used to operate the powertrain 300. The control decision 440 may be or include a changed accelerator input-output mapping or an eco mode activation or deactivation. The planner 326 is configured to determine the control decision 440 for each possible state that could arise. As a vehicle 100 operates, the plan can be further refined. That is, given a current position of the vehicle 100, the planner 326 can plan whether an accelerator input-output mapping should be changed and/or whether an eco mode activation status should be turned on or off. In an example, the powertrain control planner can use speed information from a navigation map.

The planner 326 utilizes multiple types of information regarding the current state of the vehicle 100 as inputs to the model 430. In the illustrated implementation, the inputs that are obtained (e.g., received, retrieved, generated, etc.) by the planner 326 include location information 451, a navigation map 452, a current speed 453 of the vehicle 100, an accelerator pedal state 454, a brake pedal state 455, an eco mode state 456, a following distance 457, energy consumption information 458, and a battery state 459.

Additional vehicle parameters may be used as inputs for the model 430 and can be or can include any relevant vehicle-specific information that can be used by the model 430 for determining the control decision 440. In an example, the vehicle parameters may be known a priori. In another example, the vehicle parameters can be learned. In an example, respective constants can be learned for at least some of the parameters by averaging each over time. Thus, values corresponding to at least some of the vehicle parameters can be collected from the vehicle 100 over time and then averaged. In an example, respective functions can be fit to at least some of the vehicle parameters.

The location information 451 represents the current location of the vehicle 100 relative to the vehicle transportation network 220. The location information 451 can be obtained by the planner 326 from the location unit 131 as previously described or can be determined based on information obtained from the location unit 131. As one example, the location information 451 may be expressed as a current position of the vehicle 100 in two or three dimensions and a current angular orientation of the vehicle 100. As another example, the location information 451 may be expressed relative to features of a navigation map, such as by identifying a segment (e.g., edge) or node of the navigation map at which the vehicle 100 is present.

The navigation map 452 includes geospatial information that is encoded in a computer-readable form and represents the features of the vehicle transportation network 220 in a manner that can be used by the model 430 as an input. The navigation map 452 can be defined as a directed graph <V, E> of vertices V and edges E. Each vertex v∈V can have the parameters latitude, longitude, and altitude, as shown in Table I. Each vertex v defines a coordinate in space as well as another parameter comprising a unique identifier (Id). The vertices can have fewer, more, other parameters, or a combination thereof.

TABLE I

| Parameter Name | Units | Parameter |
|---|---|---|
| Id | — | ν_{id} |
| Latitude | Degrees | νₗₐₜ |
| Longitude | Degrees | νₗₒₙ |
| Altitude | M | νₐₗₜ |

Each edge e∈E can have the parameters listed in Table II. An edge e connects two vertices. As such, an edge e can have the parameters From Vertex ID (which identifies a first node), To Vertex ID (which identifies a second node), a unique ID, and semantic road traversal information usable by the eco mode activation planner. In an example, the semantic road traversal information useful for eco mode activation planning can include one or more of the following parameters. A parameter eₙₜₜ denotes the number of times that the edge has been traversed. A parameter eats denotes the average speed of all the traversals of the edge. A parameter eₐᵢₛ denotes the average initial speed of vehicles when entering the edge. A parameter e_{afs} denotes the average exit or final speed of vehicles when exiting the edge. A parameter e_{abcr} denotes the average battery consumption/regeneration, which refers to all non-stop driving along the edge. The average battery consumption/regeneration e_{abcr} automatically incorporates the consequences of slope of the edge, road type of the edge, and traffic on the edge by simply recording, on average, how much change in battery level there was after traversal. A vertex also independently models full stops, denoting how many times a stop occurred eₙₜₛ, the duration of the stop eₐₛₜ, and how the average battery level changes from regenerative braking e_{abrs}. The parameter eₑₘₐ captures if the eco mode was active along the edge.

TABLE II

| Name | Units | Parameter |
|---|---|---|
| ID | — | e_{id} |
| From Vertex ID | — | e_{from} |
| To Vertex ID | — | eₜₒ |
| Number of Times Traversed | — | eₙₜₜ |
| Number of Times Stopped | — | eₙₜₛ |
| Average Traversal Speed | km/h | eₐₜₛ |
| Average Initial Speed | km/h | eₐᵢₛ |
| Average Final Speed | km/h | e_{afs} |
| Average Traversal Time | H | eₐₜₜ |
| Average Stop Time | H | eₐₛₜ |
| Average Battery Consumption/Regeneration | kWh | e_{abcr} |
| Average Battery Regeneration on Stop | kWh | e_{abrs} |
| Eco mode activated | — | eₑₘₐ |

In an example, the navigation map 452 can be obtained, e.g., learned, acquired, purchased, leveraged, used, etc. The navigation map 452 may be purchased from a third party (e.g., an external source) that maintains such information. The navigation map 452 can be learned as a vehicle is traversing the roads. In an example, the navigation map 452 may be an obtained navigation map that is updated by driving history of the vehicle. The navigation map 452 may be available as a callable service (such as a cloud-based service), which the planner 326 can programmatically call to request the information from the navigation map 452 that the planner requires.

In some implementations, some of the parameters of the navigation map 452 may have different semantics than those described above. To illustrate, for example in the case of a purchased navigation map, the Number of Times Traversed may be given in the form of a probability. The probability can also be computed from, for example, the number of times traversed and a number of all outgoing edges.

The navigation map 452 can include learned historical driving patterns. The navigation map 452 can include learned final goal (e.g., destination) locations. The historical driving patterns can be those of a particular vehicle for which a powertrain control plan (e.g., the policy 432) is to be calculated, those of a particular driver of the particular vehicle, those of an aggregated learned historical driving pattern of several vehicles or several drivers, or a combination thereof.

In an example, the driving history can be captured, and the navigation history can be learned from GPS traces. A GPS trace can be defined as a vector \vec{g}=<g₁, . . . , g_{|\vec{g}|}> of GPS locations along a driving path of the vehicle. The set of all GPS traces is the set G. For each GPS trace, which is formed of discrete points, the discrete points \vec{g}ᵢ, \vec{g}ⱼ∈G are paired for each contiguous road segment length that is within a pre-defined tolerance dₜₒₗ>0 from one another. In an example, the pre-defined tolerance dₜₒₗ can be 100 meters. However, other lengths are possible. The average of the beginning points and the average of the end points in the segment of \vec{g}ᵢ and \vec{g}ⱼ form two vertices. An edge can then be added to the navigation map 452 that contains the parameters of the navigation map 452, such as those described above with respect to Table III. That is, an edge that is added to the navigation map 452 can average recorded speeds, battery consumption, etc. along the segments. Adding edges to the navigation map 452 can also include adding vertices corresponding to the edge.

It is noted that average battery consumption/regeneration can be stochastic based at least on (1) the branching statistical distribution of edge traversal times (further described below) of the navigation map 452, (2) multiple possible routes splitting and joining to reach the same goal, and (3) regenerative braking during stochastic stops in slow traffic and traffic lights. Thus, the battery level at any upcoming edge of the navigation map 452 can have an associated probability distribution. This stochastic process can be naturally modeled as a Markov chain; however, actions (such as turning on or off the eco mode) can affect the battery level. Thus, the model 430 can more accurately determine powertrain control decisions.

In an example, the navigation map 452 can include two parts. A first part can be fixed (e.g., purchased, static, unchangeable) and can include parameters such as Average Speed and the like. A second part can be a learned part and is necessary for determining an optimal powertrain control plan. The second part of the navigation map 452 can be unique to the vehicle 100 (or a particular driver of the vehicle) and includes information obtained during trips made by the vehicle 100 under control of all drivers or under the control of a particular driver. Using this information, the planner 326 can determine the control decision 440 without knowing the destination of the vehicle 100.

Where the destination of the vehicle 100 is known (such as when a driver enters a destination in a routing application), the control decisions 440 may be determined based on a known route to the destination using information from the navigation map 452 for the known route. When the destination is not known, then the planner 326 may consider possible routes within a threshold distance of the vehicle 100. The possible routes may be determined based on information from the navigation map 452, such as turn probabilities, and can also be determined based on information regarding previous destinations visited by the driver of the vehicle 100.

The current speed 453 of the vehicle 100 may be a scalar value expressed in a suitable form, such as meters per second or kilometers per hour. The current speed 453 may be obtained from a wheel speed sensor, from the location unit 131, or from any other suitable source.

The accelerator pedal state 454 is a value that represents a degree of operation of an accelerator pedal of the vehicle 100 and represents a driver demand for driving torque and/or acceleration of the vehicle 100. The accelerator pedal state 454 may be a value that ranges from a minimum that represents no operation of the accelerator pedal (e.g., no force applied by the driver) and a maximum that represents full operation of the accelerator pedal. The minimum and maximum values of the accelerator pedal state may be subject to dead zones. Operation of the accelerator pedal may be sensed by a suitable type of sensor. In one implementation, a position sensor is used to measure movement of the accelerator pedal away from the resting/no operation position, and the accelerator pedal state may be a function (e.g., a linear function between minimum and maximum) of the distance (e.g., an angular distance or a linear distance) by which the driver of the vehicle 100 has moved the accelerator pedal. In an alternative, a force sensor such as a load cell is used to measure the force applied to the accelerator pedal and the accelerator pedal state may be a function (e.g., linear between minimum and maximum) of the force applied by the driver.

The brake pedal state 455 is a value that represents a degree of operation of a brake pedal of the vehicle 100 and represents a driver request for deceleration. The brake pedal state 455 may be a value that ranges from a minimum that represents no operation of the brake pedal (e.g., no force applied by the driver) and a maximum that represents full operation of the brake pedal. The brake pedal state 455 may otherwise be implemented in the manner discussed with respect to the accelerator pedal state 454.

The eco mode state 456 indicates whether the eco mode is currently active or whether a different driving mode is currently active. The eco mode state 456 may be changed (e.g., between activation and non-activation of the eco mode) by the planner 326 via the control decision 440 or by a user input. The user input may be operation of an HMI feature such as a physical button or a control displayed on a touch-sensitive input device.

The following distance 457 is a value that represents a distance between the vehicle 100 and a preceding vehicle that is travelling directly ahead of the vehicle 100 on the vehicle transportation network 220. The following distance 457 may be obtained from a sensor, such as the on-vehicle sensor 209. Suitable sensing modalities can be used, such as radar, laser, LIDAR, etc.

The energy consumption information 458 describes energy consumption by the vehicle 100 inclusive of the powertrain 300 thereof, and may be expressed in any suitable manner, such as kilowatts. As an example, the energy consumption information 458 may describe current energy use of by the powertrain 300 of the vehicle 100 under the current states of the vehicle 100. The battery state 459 represents an amount of energy available in the electric battery 318 to power the electric motor 322 and other systems of the vehicle 100. The battery state 459 may be or include a battery level (e.g., in kWh), which can be in the range of 0 to a total battery capacity. The battery state 459 may also be expressed as a state of charge percentage.

To allow access to information about the user, a profile storage system 460 may be implemented locally at the vehicle 100, for example, using the processor 133 and the memory 134, or may be located remotely, for example, as a server-based system accessed using wireless communications as previously described. The profile storage system 460 is configured to store a user profile 462 that includes information about the driver of the vehicle 100, such as driver behavior information, which is useful in determining the model 430. The user profile 462 may contain information representing behavior of the driver during previous trips, and/or may contain information determined based on driver behavior information 466 transmitted to the profile storage system 460 during or subsequent to previous trips in the vehicle 100 or in other vehicles.

The planner 326 may make decisions based on part on information obtained from a navigation system 468 of the vehicle 100. The navigation system 468 may be configured to display a map to the user, such as the navigation map 452, and may be configured to allow the user to specify a location. Using the specified location, a routing algorithm may be used (either locally or at a remote service) to determine a planned route 469. The planned route 469 may identify portions of the navigation map to be used by the vehicle 100 for travel to the destination and may provide turn-by-turn directions to the user. Information such as the selected destination and the planned route 469 may be provided to the planner 326 and used to determine the control decision as will be described herein.

The control decision 440 may be or include determination of whether to select a first powertrain control mode 442 or a second powertrain control mode 444 for use by the vehicle 100 in controlling the electric motor 322. This decision is made based on the states of the vehicle 100 that are provided to the model 430 as inputs. The first powertrain control mode 442 prioritizes performance while the second powertrain control mode 444 prioritizes efficiency. Thus, the first powertrain control mode 442 provides higher performance from the electric motor 322 of the vehicle 100 as compared to the second powertrain control mode 444, and the second powertrain control mode 444 reduces discharge of the electric battery 318 as a result of operation of the electric motor 322 of the vehicle 100 as compared to the first powertrain control mode 442.

In one implementation, the first powertrain control mode 442 includes a first accelerator input-output mapping, and the second powertrain control mode 444 includes a second accelerator input-output mapping that differs from the first accelerator input-output mapping. The first accelerator input-output mapping and the second accelerator input-output mapping may be instructions to modify a mapping that relates the degree of operation of the accelerator pedal to the desired output torque of the electric motor 322 of the vehicle 100. The first accelerator input-output mapping and the second accelerator input-output mapping may be predetermined accelerator input-output mappings. The number of possible input output mappings is not limited to two, and additional mappings including continuously variable input output mappings may be used.

As an example, the first accelerator input-output mapping may prioritize efficiency over performance, may have a lower ratio of output torque of the electric motor relative to the degree of operation of the accelerator pedal as indicated by the accelerator pedal state 454 as compared to the second accelerator input-output mapping, and may have a lower maximum torque that is commanded by maximum operation of the accelerator pedal. Similarly, the second accelerator input-output mapping may prioritize performance over efficiency, may have a higher ratio of output torque of the electric motor relative to the degree of operation of the accelerator pedal as indicated by the accelerator pedal state 454 as compared to the first accelerator input-output mapping, and may have a higher maximum torque that is commanded by maximum operation of the accelerator pedal. Thus, for the same value of the accelerator pedal state 454, a lower torque of the electric motor 322 is commanded when the first accelerator input-output mapping is used as compared to when the second accelerator input-output mapping is used.

In one implementation, the first powertrain control mode 442 is a non-eco mode (e.g., eco mode is deactivated) and the second powertrain control mode is an eco mode (e.g., eco mode is activated). The eco mode may be an explicit, user-changeable setting (e.g., using a button or other HMI element) that changes the control of the electric motor 322 between a performance-oriented mode (the non-eco mode) and an efficiency-oriented mode (the eco mode). Thus, switching between the first powertrain control mode 442 and the second powertrain control mode 444 may include switching to a mode that prioritizes performance over efficiency or may include switching to a mode that prioritizes efficiency over performance. Activating or deactivating the eco mode by changing between the first powertrain control mode 442 and the second powertrain control mode 444 may include changing the accelerator input-output mapping and/or may include other changes to the mode of operation of the powertrain 300 of the vehicle 100. Thus, control decision 440 may be or include a decision to switch operation of the vehicle from another mode to eco mode, or to switch operation of the vehicle to another mode from eco mode. The eco mode and a different control mode may each include a separate input-output torque mapping such as the first accelerator input-output torque mapping and the second accelerator input-output torque mapping described above. Other changes to the operation of the powertrain 300 may also be made between the eco mode and a different control mode.

FIGS. 4B-4C are graphs that illustrate a first relationship 470 (FIG. 4B) and a second relationship 472 (FIG. 4C) between the accelerator pedal state 454 and a resulting motor output 474 (e.g., torque) of the electric motor 322 according to an example. The first relationship 470 may correspond to operation in the first powertrain control mode 442, and the second relationship 472 (FIG. 4C) may correspond to operation in the second powertrain control mode 444.

The first relationship 470 depicts a higher performance mode as compared to the second relationship 472, and may correspond, for example, to operation of the powertrain 300 when the eco mode is deactivated. The second relationship 472 depicts a lower performance mode as compared to the first relationship 470, and may correspond, for example, to operation of the powertrain 300 when the eco mode is activated. The x-axis denotes the magnitude of the accelerator pedal state 454, such as a distance, angle, or pressure by which the accelerator pedal (or other accelerator input) is activated by the driver. The y-axis indicates the resulting magnitude of the output of the electric motor 322, such as a torque output of the electric motor 322 which is related to acceleration of the vehicle 100 as a result of operation of the electric motor 322. The first relationship 470 shows that, in the first powertrain control mode 442, the motor output 474 increases more rapidly in response to operation of the accelerator as compared to equivalent operation of the accelerator in the second powertrain control mode 444, as seen in the second relationship 472. The higher level of the motor output 474 for the first powertrain control mode 442 as compared to the second powertrain control mode 444 for equivalent values of the accelerator pedal state 454 allows for higher performance operation in the first powertrain control mode 442 and allows for higher efficiency operation in the second powertrain control mode 444 in response to equivalent driver operation of the accelerator.

With further reference to FIG. 4A, the control module 324 operates the vehicle 100 according to the control decision 440. In an example, the control module 324 may directly communicate with (e.g., transmit signals or commands to, etc.) the electric motor 322 to change the accelerator input-output mapping and/or to activate (e.g., turn on or off) the eco mode according to the control decision 440. In an example, the control module 324 may transmit the control decision 440 to an electric motor control module (not shown) that implements the control decision 440 by changing the accelerator input-output mapping and/or by activating the eco mode.

Powertrain control planning, as implemented by the planner 326, can be performed using the model 430, which is configured to make a decision through an optimization process that considers two or more conflicting objectives. The conflicting objectives include performance and energy efficiency in the system described herein and may include other objectives. In one implementation, powertrain control planning is modeled as a multi-objective Markov decision process (MOMDP) problem, which is a type of Markov decision process (MDP) problem. MOMDP is a framework for sequential decision-making in environments in which multiple, often conflicting objectives must be optimized simultaneously. It extends the MDP by considering vector-valued rewards, where each component of the reward vector corresponds to a different objective. Thus, instead of optimizing a single scalar reward, an MOMDP is intended to optimize a set of objectives.

The decision model can be formally modeled as a tuple <S, A, T, C>. The variable S (e.g., S^{T}×S^{B}×S^{M}) can be a finite set of state (e.g., S^{T}—current road, S^{B}—battery level, S^{M}-accelerator input-output mapping or eco mode status). The variable A can be a finite set of actions (e.g., use first accelerator input-output mapping, use second accelerator input-output mapping, eco mode on, eco mode off). The variable T (e.g., T(s, a, s″)) can be a state transition function that represents the probability that successor state s′∈S occurs after performing an action a∈A in a state s∈S. The variable C(s, a) can represent a cost function that represents the expected immediate cost(s) of performing an action a∈A in a state s∈S. Additionally, there can be multiple distinct cost functions (e.g., multi-dimensional cost vector). The multiple distinct cost functions may consider objectives including, but not limited to performance, energy efficiency, safety, stability, and travel time. Other objectives may be modeled by the cost functions.

A solution to the model can be a policy π:S→A (e.g., the policy 432). That is, under the policy π, an action a (e.g., π(s)) is selected for a state s. That is, the policy π can indicate that the action π(s)∈A should be taken in state s. The policy π can include a value function V^{π}:S→C that can represent the expected cumulative cost V^{π}(s) of reaching a goal state, from a state s following the policy π. That is, the value function can provide an expected cost (e.g., a value) for each intermediate state, from the start state until a goal state is reached. An optimal policy π* minimizes the expected cumulative cost. To achieve a balance between different control strategies, the decision model may employ multiple scalarization functions, e.g., within an MOMDP. Different scalarization functions translate the multi-dimensional cost vector into a single cost value, thereby accommodating varying optimization priorities.

With respect to the costs C, several cost functions can be considered. In an implementation, the cost functions include a performance cost function C_{perf}, an efficiency cost function C_{eco}, a safety cost function C_{safe}, and a stability cost function C_{stable}. The performance cost function C_{perf} results in a high cost for operation in an efficiency-focused mode when there is a demand for high performance (e.g., high speed and/or acceleration). The efficiency cost function C_{eco} results in a high cost for operation in a performance-focused mode, based on the current energy consumption and the battery level. The safety cost function, C_{safe}, is designed to ensures that changes to the performance available from the electric motor 322 do not compromise safety by selectively suppressing transition from a higher performance mode to a lower performance mode. The stability cost C_{stable} is intended to reduce the occurrence of frequent mode switching and may be determined based on the elapsed time since the last mode switch.

Different cost functions or additional cost functions may be used depending on the situation and depending on the different types of modes that are available for use by the vehicle 100. The costs computed from the individual cost functions are combined to determine a total cost. This combination may be a sum, a weighted sum, or another type of combination. Other costs are also possible. While the objective of the model (in this example the MOMDP) is to minimize the expected costs over time, the cost functions are the costs associated with a next immediate one-step cost of the next powertrain control decision.

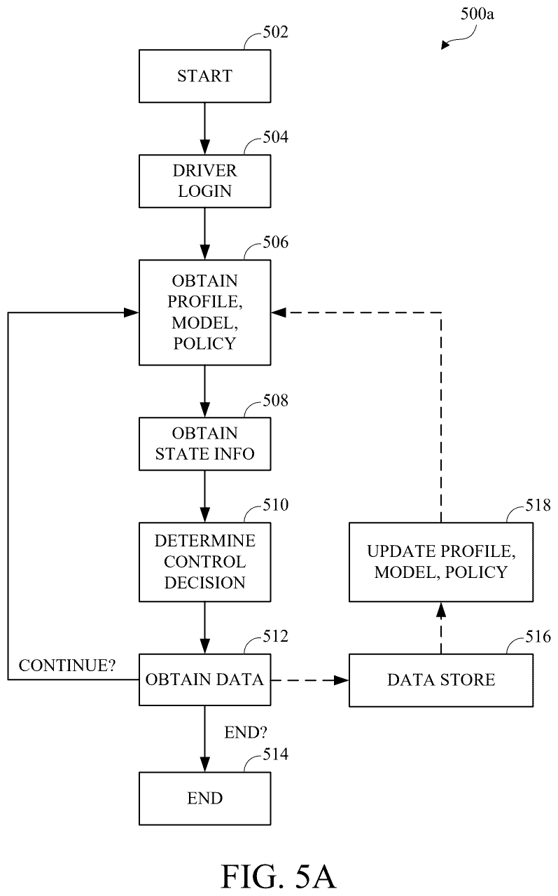

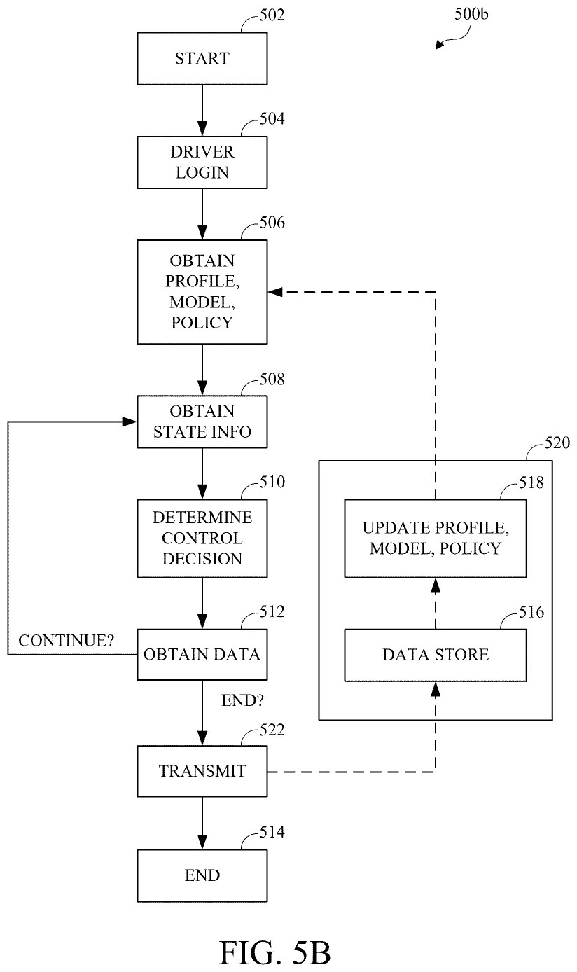

FIG. 5A is an illustration of an example 500a of operation of the vehicle 100. In the example 500a, the user profile 462, the model 430, and/or the policy 432 are updated locally on the vehicle 100 using the driver behavior information 466 that is obtained during a drive of the vehicle 100. The example 500a starts in block 502, which may be the beginning of the drive, such as when the driver enters the vehicle 100 and prepares to begin driving the vehicle. In block 504, a driver login is performed, which includes identifying the driver, such as by presence of a physical key fob, a mobile phone associated with the driver, a biometric identification (e.g., facial recognition, fingerprint recognition, or similar methods), a secret code number, a username and password combination, or other identification method.

In block 506, the identification of the driver is used as a basis for obtaining the user profile 462 for the driver, and for obtaining the model 430 and/or the policy 432. In the implementation of FIG. 5A, the model 430 and/or the policy 432 may be located on the vehicle 100 and may be updated (e.g., modified, recalculated, trained, etc.) during operation of the vehicle 100 in response to changes in the user profile 462, such as when information is added to the user profile 462. The user profile 462 for the driver may be obtained from local storage (e.g., by the controller 130) at the vehicle 100, may be obtained from an external service such as a remote server (e.g., by accessing the communication device 240 using the electronic communication network 230), or may be obtained by creating a new profile. When the user profile 462 is created, it may be initialized, for example, by creating a copy of the user profile 462 that contains default values, by creating a copy of the user profile 462 programmatically, by creating a new file for the user profile 462 that initially contains no values, or by any other suitable technique. The policy 432 may similarly be obtained from local storage or storage at a remote server, by computing the policy 432 locally or remotely using the model 430, by using a default version of the policy 432 until the policy can be recomputed using the user profile 462, or in another suitable way.

Block 508 occurs while the vehicle 100 is being driven. As an example, this may occur during travel from a current location of the vehicle 100 toward a destination location, and may be performed using the planned route 469, which is determined by the navigation system 468 using the current location and the destination location for the vehicle 100 as inputs. In block 508, state information is obtained. The state information includes states of the vehicle 100, including driver inputs and information obtained from various systems of the vehicle 100.

The inputs to the planner 326 that were described with reference to FIG. 4 are examples of state information that can be obtained by the vehicle 100 in block 508 for use by the planner 326 in making the control decision 440 based on the user profile 462, the model 430, and the policy 432. The state information obtained in block 508 also includes information about the environment around the vehicle 100. This information may be obtained from the sensor 136 of the vehicle, from the navigation map 452, or from an external source such as the communication device 240 via the electronic communication network 230. For example, weather information or traffic information may be obtained from a remote server. The information may also be obtained from other sources.

In block 510, the control decision 440 may be determined based on the state information obtained in block 508 by the planner 326. The planner utilizes the current states as inputs to the model 430 and/or the policy 432 and determines the outputs thereof. As examples, the outputs may include the control decision 440, such as instructions to utilize one of the first powertrain control mode 442 or the second powertrain control mode 444, and/or instructions regarding how to operate the vehicle 100 in the first powertrain control mode 442 and/or the second powertrain control mode 444. The resulting decisions are utilized to control the vehicle 100, such as by modifying operation of the powertrain 300 and/or another system of the vehicle 100.

In block 512, data is obtained regarding the operation of the vehicle 100. The data obtained in block 512 may be or include the driver behavior information 466. As one example, the driver behavior information 466 may be added to the user profile 462. As one example, values derived from the driver behavior information 466 may be added to the user profile 462, such as by updating a rolling average value from the user profile 462 with new data values that are included in the driver behavior information 466.

Various types of information may be included in the driver behavior information 466 that is obtained and stored in block 512. The driver behavior information 466 may include acceleration patterns, such as frequency and intensity of pedal input, rate of change of accelerator pedal position, and duration of sustained high torque requests. The driver behavior information 466 may also include braking behavior. This includes the frequency of braking events, deceleration rate, and whether braking involves coasting or immediate braking. Speed maintenance information may also be included. Examples are preferred cruising speed, variability in speed, time spent at high speeds, throttle-off behavior, use of coasting versus regenerative braking, and the frequency and duration of zero-throttle conditions. Gear selection and shift behavior can also be recorded, such as the choice of upshifting or downshifting and the duration spent in high versus low gears. The driver behavior information 466 may further capture cornering and steering behavior, including lateral acceleration, steering angle changes, frequency of corrections, and how speed is maintained through corners. Stop-and-go driving patterns may be noted, such as behavior in traffic, smooth versus jerky starts from a stop, and idling behavior. Driving mode selection, including the frequency of driver activation of specific control modes and override of automatic mode suggestions, may also be included. Information regarding adaptive cruise control (ACC) behavior, such as gap settings to vehicles ahead and acceleration or deceleration behavior under ACC, is captured as well. The driver behavior information 466 may include overtaking and passing behavior, such as the frequency and aggressiveness of overtaking maneuvers and acceleration rates during passing events. Terrain and environment adaptation information may also be tracked. This includes driving behavior changes on inclines, declines, rough terrain, urban driving patterns, and highway driving patterns. Information regarding responses to external stimuli may be included. This includes reaction to traffic lights, behavior in merging lanes and traffic congestion, interaction with eco/performance feedback systems, reactions to real-time driving feedback, and compliance with efficiency recommendations. The driver behavior information 466 may associate any or all of this information with environmental conditions observed at the time. Examples include differing driver preferences in various weather conditions (e.g., clear, rain, snow), environments (e.g., city, suburb, freeway), and traffic conditions (e.g., free flow, moderate traffic, heavy traffic). Additional types of information may be included in the driver behavior information 466 as needed.

Subsequent to each iteration of block 512, a determination is made as to whether operation of the vehicle 100 is continuing (e.g., the vehicle 100 is still being driven) or whether operation of the vehicle 100 has ended. If the operation of the vehicle 100 has ended, the flow ends at block 514. If operation of the vehicle 100 continues, the flow may return to block 506 for additional iterations of blocks 506, 508, 510 and 512. It should be understood that while the processes performed in these blocks are described as occurring sequentially for ease of explanation, they may instead be occurring in parallel, or iterations of these processes may be performed at different frequencies.

The data obtained in block 512 is transmitted to a data store 516. In this implementation, the data store 516 is implemented locally by the vehicle 100, such as by the controller 130 of the vehicle 100. The data that is collected in the data store 516 is utilized to update the user profile 462, the model 430, and/or the policy 432 in block 518. As an example, the user profile 462 may initially lack user-specific information for the second parameter values 465, but this data is obtained during the drive. Using this data, the user profile 462 is updated to include the second parameter values 465, and the model 430 and/or the policy 432 may be updated during the drive based on the new information. Thus, in the current implementation, updates to the user profile 462, the model 430, and the policy 432 may occur on the vehicle 100 (e.g., performed by the controller 130) using the driver behavior information 466 and may be performed during operation of the vehicle 100. The updates performed in block 518 may be performed periodically, and the updates are applied in block 506 when available. The updates performed in block 518 may occur at a much slower rate than iterations of blocks 506, 508, 510, and 512, and therefore, updates only need to be applied in block 506 when they are available.

FIG. 5B is an illustration of an example 500b of operation of the vehicle 100. In the example 500b, the user profile 462, the model 430, and/or the policy 432 are updated by an external service such as a remote server 520 implemented according to the description of the communication device 240. The vehicle 100 may be in communication with the remote server 520 using the electronic communication network 230 or in another way. In this example, the driver behavior information 466 that is obtained during a drive of the vehicle 100 is transmitted to the remote server 520 after the driver is completed. The user profile 462, the model 430, and/or the policy 432 are updated offline, for example, subsequent to the drive, by performing the update at the remote server 520 using data transmitted to the remote server 520 from the vehicle 100. The updated versions of the user profile 462, the model 430, and/or the policy 432 may be obtained by the vehicle 100 in advance of a drive, for example, by receiving an update when the vehicle 100 is not in use.

In the example 500b, blocks 502, 504, 506, 508, 510, and 512 are as previously described, except as stated otherwise herein. Obtaining the user profile 462, the model 430, and/or the policy 432 may be performed in block 506 only at the beginning of the drive, and the obtained information may be utilized during the drive without being updated. Thus, multiple iterations of blocks 508, 510, and 512 may be performed without updating the user profile 462, the model 430, and/or the policy 432. The data obtained in block 512, such as the driver behavior information 466, is not transmitted to the data store 516 during the drive but is instead stored locally on a temporary basis until the drive is completed. After block 512, the drive may be continued by returning to block 508, or ended by proceeding to block 522, where the data obtained during the drive, such as the driver behavior information 466, is transmitted to the data store 516. In this example, the data store 516 is located at the remote server 520 and the update of block 518 is performed at the remote server. The updated versions of the user profile 462, the model 430, and/or the policy 432 may be transmitted to the vehicle 100 by the remote server 520 prior to the next drive of the vehicle 100. After transmission of the data in block 522, the drive ends in block 514.

It should be noted that the remote server 520 may also be used in conjunction with the example 500a. For example, the user profile 462, the driver behavior information 466, the model 430, and/or the policy 432 may be transmitted from the vehicle 100 to the remote server 520 after a drive by the vehicle 100. This allows for backup of the information so that it is not inadvertently lost. This also allows for use of the information in a different vehicle subsequent to obtaining the driver behavior information 466 in the vehicle 100.

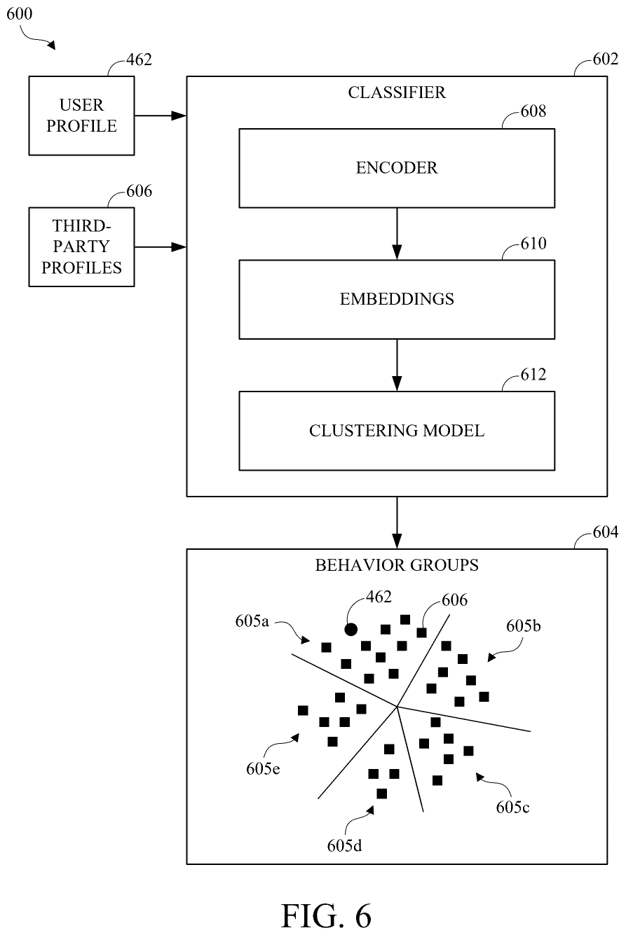

FIG. 6 is a block diagram of a classification system 600. The classification system 600 includes a classifier 602 that is configured to define two or more behavior groups 604 and to assign the user profile 462 to one of the behavior groups 604. The classifier 602 is also tasked with assigning third-party profiles 606 to one of the behavior groups. The third-party profiles 606 are similar to the user profile 462 but are created for other users. The third-party profiles 606 are defined using information equivalent to the driver behavior information 466. The third-party profiles 606 may include multiple groups of parameter values that are relevant to different modes of the vehicle 100 (or other vehicles), such as parameter values that are equivalent to the first parameter values 464 and the second parameter values 465 as previously discussed.

Using the driver behavior information 466 from the user profile 462, and the information from the third-party profiles 606, drivers are clustered based on similarity of behaviors. As will be described, these clusters can be used to augment the information available in the user profile 462 when adequate information is not present in the user profile 462. As an example, the behavior groups 604 can be used to infer what the driver's preferences would be in circumstances they have not yet encountered by using data collected from vehicle operation by similar drivers. Previously unencountered circumstances may include travel to a new location that the driver has not previously driven in, a vehicle mode that the driver has not previously used, or use of a different vehicle with new features or mode optimizations.

In an implementation, the classifier 602 employs unsupervised clustering techniques to define behavior groups 604 using driver behavior information 466 from the user profile 462 and from the third-party profiles 606. This allows the behavior groups 604 to be defined by clustering without relying on pre-existing behavior archetypes. The classification system utilizes the information previously described with respect to the driver behavior information 466, which may include information describing the states of the vehicle 100 and the environment around the vehicle 100 at the time the behavior occurred, such as any information used as an input by the planner 326 as previously described. Thus, the information provided to the classifier 602 may include information collected from multiple sensors and sources, and may include information such as location information such as altitude, latitude, and longitude parameters, as well as vehicle CAN bus data that measure values like velocity, steering inputs, brake pedal activity, accelerator pedal usage, and following distance. Additional data can be collected from sensor systems such as LIDAR and video systems, to incorporate information about the environment, static objects in the environment, and dynamic objects in the environment.

In the illustrated implementation, the classifier 602 includes an encoder 608 that generates embeddings 610 that are provided to a clustering model 612 as an input. The encoder 608 receives the information from the user profile 462 and the third-party profiles 606 and determines the embeddings 610. The embeddings 610 are compact representations of the input data in an encoded form that allows for analysis. The embeddings 610 define a feature space that can be used for clustering. The embeddings 610 are analyzed by the clustering model 612, which is configured to define the behavior groups 604 and to assign the user profile 462 and each of the third-party profiles 606 to one of the behavior groups 604. The clustering model 612 can utilize various clustering techniques, including K-Means clustering to partition drivers based on feature similarity, hierarchical clustering to organize drivers into multi-level groupings, and density-based clustering methods like DBSCAN, which identify dense regions of similar behaviors. Deep clustering techniques can also be used, enabling neural networks to simultaneously learn the data embeddings and determine clusters. Different supervised, semi-supervised or unsupervised learning methods could be used by the classifier 602 to classify or cluster driver behavior.

The clustering model dynamically defines behavior groups 604 by analyzing the driver behavior information 466 and the extracted embeddings, rather than relying on pre-established archetypes. The behavior groups 604 represent clusters of similar behaviors, such as a first behavior group 605a, a second behavior group 605b, a third behavior group 605c, a fourth behavior group 605d, and a fifth behavior group 605e. This allows the behavior groups 604 to adaptively reflect the diversity of driving patterns identified in the input data. The clustering model can operate either locally within the vehicle 100 or at a remote service, such as a server implemented according to the description of the communication device 240.

The behavior groups 604 identified by the clustering process allow the classification system 600 to augment the user profile 462. This augmentation enables the system to predict driver preferences in situations not yet encountered, such as driving in a new location, using vehicle modes or features for the first time, or operating a vehicle under unfamiliar conditions. By analyzing data from third-party profiles 606 in similar behavior groups, the classification system 600 infers preferences and optimizes responses to new circumstances. In the illustrated implementation, the user profile 462 is assigned to the first behavior group 605a (represented by a circle) and can utilize information, such as the first parameter values 464 and/or the second parameter values 465 from the third-party profiles 606 (represented by squares) that are also assigned to the first behavior group 605a when it is determined that the user profile 462 lacks certain parameters (or is using default values for certain parameters).

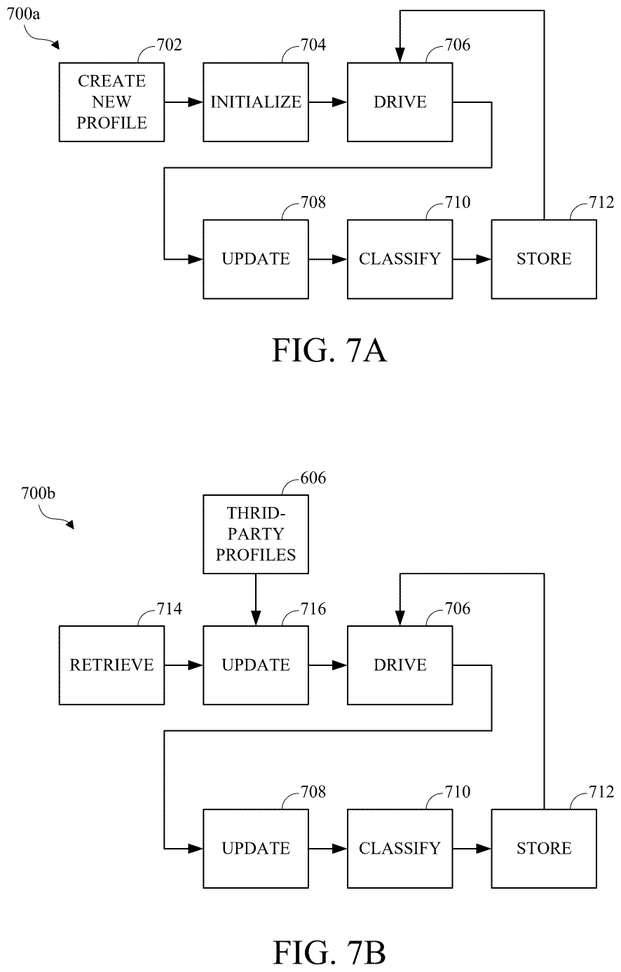

FIG. 7A illustrates a process 700a for creating, updating, and classifying the user profile 462. The process 700a may be used when a new driver who has not previously driven the vehicle 100 logs in to drive the vehicle 100 for the first time. The process 700a begins with creation of a new instance of the user profile 462 at block 702, where a new version of the user profile 462 is created, such as by creating a copy of the user profile 462. At block 704, the user profile 462 is initialized, such as by setting values in the user profile 462 to default values. When the driver operates the vehicle 100 during a drive at block 706, the driver behavior information 466 is collected. Then, the driver behavior information 466 collected in block 706 is processed, and the user profile 462 is updated in block 708. The updated data is classified in block 710 using clustering techniques as previously described and is stored in block 712 for future use. The process 700a incorporates a feedback loop, where updated user profile 462 and updated version of the model 430 and/or the policy 432 are provided to the vehicle 100 for use during the next drive.

FIG. 7B illustrates a process 700b for transferring the user profile 462 to a new vehicle and updating it using third-party data. The process begins at block 714, where the user profile 462 created in FIG. 7A is retrieved, such as from a remote server where the user profile 462 is stored. At block 716, the retrieved user profile is updated to account for the capabilities of the new vehicle using information from the third-party profiles 606 from the same one of the behavior groups 604 that the user profile is classified in as described with respect to the classification system 600. This may include adding the second parameter values 465 to the user profile 462 using the information from the third-party profiles 606 because the user profile 462 initially lacks the second parameter values 465. The process 700b then continues with blocks 706, 708, 710, and 712, which are as described with respect to the process 700a.

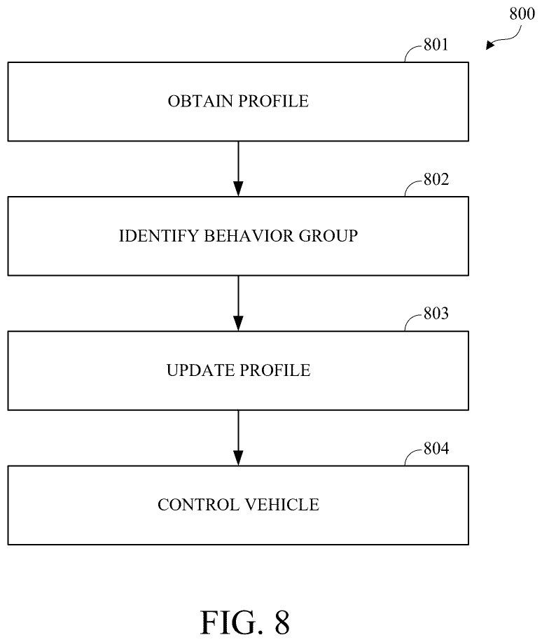

FIG. 8 is a diagram of an example of a process 800 for determination of a powertrain control decision, such as the control decision 440, in accordance with an embodiment of this disclosure. The process 800 can be implemented, partially or fully, by a BEV, such as the vehicle 100 equipped with the powertrain 300. The process 800 can be implemented in a manually controlled vehicle, an autonomous vehicle (AV), a semi-autonomous vehicle, or in vehicles that include other types of drive-assist capabilities, including remote control of the vehicle. The process 800 can be implemented as instructions that are stored in a memory, such as the memory 134 of FIG. 1. The instructions can be executed by a processor, such as the processor 133 of FIG. 1. The process 800 may be performed in whole or in part by hardware.

Operation 801 of the process 800 includes obtaining the user profile 462 for the current driver of the vehicle 100. The user profile 462 includes the first parameter values 464 that are associated with the first powertrain control mode 442 and lacks the second parameter values 465 that are associated with the second powertrain control mode 444. As an example, the user profile 462 may lack the second parameter values 465 because the driver has not previously operated the vehicle 100 in the second powertrain control mode 444 or the driver has not previously operated the vehicle 100 in the second powertrain control mode 444 under a set of environmental conditions (e.g., weather, location, traffic volume) that the vehicle 100 is currently operating in. Other situations may result in the user profile 462 lacking the second parameter values 465.

In one implementation, the obtaining the user profile 462 in operation 801 includes accessing a copy of the user profile 462 that is stored locally at the vehicle 100. As an example, the user profile 462 may be stored by implementing the profile storage system 460 locally at the vehicle 100 using the controller 130 of the vehicle 100.

In another implementation, obtaining the user profile 462 in operation 801 includes receiving the user profile 462 from an external service. In an example of obtaining the user profile the user profile 462 from an external service, the user profile 462 may be stored by an implementation of the profile storage system 460 that is located at a remote server such as the communication device 240. In this example, the user profile 462 is obtained by transmitting a copy of the user profile 462 from the profile storage system 460 to the vehicle 100 using the electronic communication network 230 or another suitable communications system.

In another implementation, obtaining the user profile 462 in operation 801 includes transferring the user profile 462 from a first vehicle (e.g., a vehicle previously used by the driver) that does not support the second powertrain control mode 444 to a second vehicle, such as the vehicle 100, that does support the second powertrain control mode 444, and controlling the vehicle powertrain is performed using the second vehicle. Transfer of the user profile 462 may be accomplished using the using the electronic communication network 230 or another suitable communications system. In this context, the term “transfer” includes creating a copy of the user profile 462 at the second vehicle based on the information received from the first vehicle, regardless of whether a copy of the user profile 462 remains at the first vehicle.

In another implementation of obtaining the user profile 462 in operation 801, a new instance of the user profile 462 may be initialized and populated with information obtained during operation of the vehicle 100 by the driver. This may be done, for example, when the driver of the vehicle 100 has not previously created a profile, or when the existing profile belonging to the driver is not available due to a communications problem or other reason.

The first powertrain control mode 442 and the second powertrain control mode 444 are operating modes for the vehicle 100 that control aspects of how the electric motor 322 and/or other system of the vehicle are operated during the drive. The first parameter values 464 and the second parameter values 465 are values that are used to control transition into each of the first powertrain control mode 442 and the second powertrain control mode 444 and/or to control operation of the vehicle 100 in each of the first powertrain control mode 442 and the second powertrain control mode 444. In this example, the first parameter values 464 for the first powertrain control mode 442 are known based on driver information data that was previously collected for the driver of the vehicle 100. In this example, the vehicle 100 does not have access to values for the second parameter values 465 for the second powertrain control mode 444 that are based on driver information data that was previously collected for the driver of the vehicle 100. Instead, the second parameter values 465 may be unavailable (e.g., the values are not included in the user profile 462 or the values in the user profile 462 are default values that are not specific to the driver).

In one implementation, the first powertrain control mode 442 and the second powertrain control mode 444 in operation 801 may each be one of an eco mode, a sport mode, a snow mode, an off-road mode, a two-wheel drive mode, a four-wheel drive mode, an all-wheel drive mode, a front-wheel drive mode, an engine on/off mode, an e-pedal mode, a low regenerative braking mode, or a high regenerative braking mode.

Operation 802 of the process 800 includes identifying the behavior group, such as the first behavior group 605a in this example, for the driver based on similarity of the user profile 462 to third-party profiles in the first behavior group 605a.

As one example, identifying the first behavior group 605a for the driver of the vehicle 100 based on the similarity of the user profile 462 to the third-party profiles 606 in the first behavior group 605a includes accessing information in the user profile 462 that identifies the first behavior group 605a As another example, identifying the first behavior group 605a for the driver of the vehicle 100 based on the similarity of the user profile 462 to the third-party profiles 606 in the first behavior group 605a includes receiving information identifying the first behavior group 605a from an external service. In another example, identifying the first behavior group 605a for the driver of the vehicle 100 based on similarity of the user profile 462 to the third-party profiles 606 in the first behavior group 605a using a classification technique such as a clustering model.

Operation 803 of the process 800 includes updating the user profile 462 based on the third-party profiles 606 to include the second parameter values 465. As one example, the second parameter values 465 may be copied from one or more of the third-party profiles to the user profile 462. As another example, averaged values may be determined based on the values from two or more of the third-party profiles and used as the second parameter values 465. Other techniques for determining the second parameter values for the driver of the vehicle 100 based on the third-party profiles may be used.

Operation 804 of the process 800 includes controlling a vehicle powertrain, such as the powertrain 300, based on the user profile 462. In some implementations, controlling the powertrain 300 based on the user profile 462 includes determining whether to activate one of the first powertrain control mode 442 or the second powertrain control mode 444 based on the user profile 462. For example, the control decision 440 indicates whether to activate the first powertrain control mode 442 or the second powertrain control mode 444 and may be made using cost functions that consider information from the user profile 462.

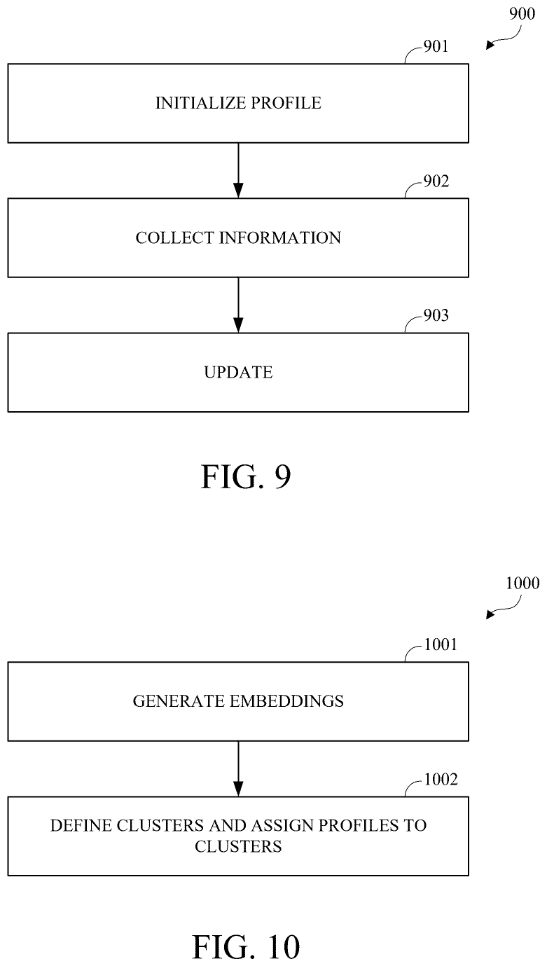

FIG. 9 is a diagram of an example of a process 900 for obtaining the user profile 462, in accordance with an embodiment of this disclosure. The process 900 may be incorporated in the process 800 as an implementation of operation 801. The process 900 can be implemented, partially or fully, by a BEV, such as the vehicle 100 equipped with the powertrain 300. The process 900 can be implemented in a manually controlled vehicle, an autonomous vehicle (AV), a semi-autonomous vehicle, or in vehicles that include other types of drive-assist capabilities, including remote control of the vehicle. The process 900 can be implemented as instructions that are stored in a memory, such as the memory 134 of FIG. 1. The instructions can be executed by a processor, such as the processor 133 of FIG. 1. The process 900 may be performed in whole or in part by hardware.

Operation 901 includes initializing the user profile 462. Initially, the vehicle 100 may lack a user profile for the driver of the vehicle 100, a user profile for the driver may likewise not exist at an external service, and/or the vehicle may be unable to obtain a user profile for the driver from an external service due to a communications problem or other reason. As one example, initializing the user profile 462 may include obtaining a copy of a default user profile that does not contain information specific to the driver of the vehicle 100. As another example, initializing the user profile 462 may include generating a new instance of the user profile 462 programmatically.

Operation 902 includes collecting the driver behavior information 466 from one or more vehicle systems of the vehicle 100 during a drive. The driver behavior information 466 that is collecting by the vehicle 100 during the driver includes the first parameter values 464 that are associated with the first powertrain control mode 442 but may lack the second parameter values 465 that are associated with the second powertrain control mode 444.

In some implementations of operation 902, collecting the driver behavior information 466 from the one or more vehicle systems of the vehicle 100 during the drive includes obtaining one or more of velocity information, a steering input value, a braking input value, an accelerator input value, and a following distance. In some implementations of operation 902, collecting the driver behavior information 466 from the one or more vehicle systems of the vehicle 100 during the drive includes obtaining sensor information representing one or more objects in an external environment. By correlating information about the external environment with information from vehicle systems indicating how the driver controlled the vehicle 100 in the presence of those environmental conditions, the information included in the user profile 462 may be improved. For example, driver behaviors may differ in the absence and presence of nearby external objects.

Operation 903 includes updating the user profile 462 based on the first parameter values 464 from the driver behavior information 466 that was collected in operation 902. As an example, the first parameter values 464 may be values obtained (e.g., measured, recorded, etc.) during the driver, and these values may be incorporated in the user profile 462.

FIG. 10 is a diagram of an example of a process 900 for identifying one of the behavior groups 604 for the driver based on similarity of the user profile 462 to the third-party profiles 606 in the same behavior group, such as the first behavior group 605a, in accordance with an embodiment of this disclosure. The process 1000 may be incorporated in the process 800 as an implementation of operation 802. The process 1000 can be implemented, partially or fully, by a BEV, such as the vehicle 100 equipped with the powertrain 300. The process 1000 can be implemented in a manually controlled vehicle, an autonomous vehicle (AV), a semi-autonomous vehicle, or in vehicles that include other types of drive-assist capabilities, including remote control of the vehicle. The process 1000 can be implemented as instructions that are stored in a memory, such as the memory 134 of FIG. 1. The instructions can be executed by a processor, such as the processor 133 of FIG. 1. The process 1000 may be performed in whole or in part by hardware.

Operation 1001 includes generating the embeddings 610 based on the user profile 462 and each of the third-party profiles 606. This can be performed in the manner described with respect to the encoder 608 and the embeddings 610.

Operation 1002 includes assigning the user profile 462 and the third-party profiles 606 to the first behavior group 605a or another one of the behavior groups 604 based on the embeddings 610 using the clustering model 612, wherein the first behavior group 605a is one of multiple behavior groups, such as the behavior groups 604, each representing a different cluster of driver behavior types.

The above-described processes can be implemented, for example, as a method, as an apparatus that include a memory subsystem, and one or more processors configured to execute instructions stored in the memory subsystem, and as a non-transitory computer-readable medium storing instructions operable to cause one or more processors to perform operations.

As used herein, the terminology “instructions” may include directions or expressions for performing any method, or any portion or portions thereof, disclosed herein, and may be realized in hardware, software, or a combination thereof. For example, instructions may be implemented as information, such as a computer program, stored in memory that may be executed by a processor to perform any of the respective methods, algorithms, aspects, or combinations thereof, as described herein. Instructions, or a portion thereof, may be implemented as a special purpose processor, or circuitry, which may include specialized hardware for carrying out any of the methods, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

As used herein, the terminology “example”, “embodiment”, “implementation”, “aspect”, “feature”, or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify”, or any variations thereof, includes selecting, ascertaining, computing, looking up, receiving, determining, establishing, obtaining, or otherwise identifying or determining in any manner whatsoever using one or more of the devices shown and described herein.

As used herein, the terminology “or” is intended to mean an inclusive “or” rather than an exclusive “or” unless specified otherwise, or clear from context. In addition, the articles “a” and “an” as used in this application and the appended claims should generally be construed to mean “one or more” unless specified otherwise or clear from context to be directed to a singular form.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

The above-described aspects, examples, and implementations have been described in order to allow easy understanding of the disclosure are not limiting. On the contrary, the disclosure covers various modifications and equivalent arrangements included within the scope of the appended claims, which scope is to be accorded the broadest interpretation so as to encompass all such modifications and equivalent structure as is permitted under the law.

What is claimed is:

1. A method, comprising:
obtaining a user profile that includes first parameter values associated with a first powertrain control mode and lacks second parameter values associated with a second powertrain control mode;
identifying a behavior group based on similarity of the user profile to third-party profiles in the behavior group;
updating the user profile based on the third-party profiles to include the second parameter values; and
controlling a vehicle powertrain based on the user profile.

2. The method of claim 1, wherein obtaining the user profile further comprises:
initializing the user profile;
collecting driver behavior information from one or more vehicle systems during a drive, wherein the driver behavior information includes the first parameter values associated with the first powertrain control mode; and
updating the user profile based on the first parameter values from the driver behavior information.

3. The method of claim 2, wherein collecting the driver behavior information from the one or more vehicle systems during the drive includes obtaining one or more of velocity information, a steering input value, a braking input value, an accelerator input value, and a following distance.

4. The method of claim 3, wherein collecting the driver behavior information from the one or more vehicle systems includes obtaining sensor information representing one or more objects in an external environment.

5. The method of claim 1, wherein obtaining the user profile further comprises receiving the user profile from an external service.

6. The method of claim 1, wherein obtaining the user profile includes transferring the user profile from a first vehicle that does not support the second powertrain control mode to a second vehicle that does support the second powertrain control mode, and controlling the vehicle powertrain is performed using the second vehicle.

7. The method of claim 1, wherein controlling the vehicle powertrain based on the user profile includes determining whether to activate one of the first powertrain control mode or the second powertrain control mode based on the user profile.

8. The method of claim 1, wherein identifying the behavior group based on the similarity of the user profile to the third-party profiles in the behavior group comprises receiving information identifying the behavior group from an external service.

9. The method of claim 1, wherein identifying the behavior group based on the similarity of the user profile to the third-party profiles in the behavior group comprises:
generating embeddings based on the user profile and each of the third-party profiles; and
assigning the user profile and the third-party profiles to the behavior group based on the embeddings using a clustering model, wherein the behavior group is one of multiple behavior groups each representing a different cluster of driver behavior types.

10. The method of claim 1, wherein the first powertrain control mode and the second powertrain control mode are each one of an eco mode, a sport mode, a snow mode, an off-road mode, a two-wheel drive mode, a four-wheel drive mode, an all-wheel drive mode, a front-wheel drive mode, an engine on/off mode, an e-pedal mode, a low regenerative braking mode, or a high regenerative braking mode.

11. An apparatus, comprising:
a memory subsystem; and
one or more processors configured to execute instructions stored in the memory subsystem to:
obtain a user profile that includes first parameter values associated with a first powertrain control mode and lacks second parameter values associated with a second powertrain control mode;
identify a behavior group based on similarity of the user profile to third-party profiles in the behavior group;
update the user profile based on the third-party profiles to include the second parameter values; and
control a vehicle powertrain based on the user profile.

12. The apparatus of claim 11, wherein the instructions to obtain the user profile further comprise instructions to:
initialize the user profile;
collect driver behavior information from one or more vehicle systems during a drive, wherein the driver behavior information includes the first parameter values associated with the first powertrain control mode; and
update the user profile based on the first parameter values from the driver behavior information.

13. The apparatus of claim 11, wherein the instructions to obtain the user profile further comprise instructions to receive the user profile from an external service.

14. The apparatus of claim 11, wherein the instructions to obtain the user profile further include instructions to transfer the user profile from a first vehicle that does not support the second powertrain control mode to a second vehicle that does support the second powertrain control mode, and control of the vehicle powertrain is performed by the second vehicle.

15. The apparatus of claim 11, wherein the instructions to control the vehicle powertrain based on the user profile include instructions to determine whether to activate one of the first powertrain control mode or the second powertrain control mode based on the user profile.

16. A non-transitory computer-readable storage medium storing instructions operable to cause one or more processors to perform operations comprising:
obtaining a user profile that includes first parameter values associated with a first powertrain control mode and lacks second parameter values associated with a second powertrain control mode;
identifying a behavior group based on similarity of the user profile to third-party profiles in the behavior group;
updating the user profile based on the third-party profiles to include the second parameter values; and
controlling a vehicle powertrain based on the user profile.

17. The non-transitory computer-readable storage medium of claim 16, wherein obtaining the user profile further comprises:
initializing the user profile;
collecting driver behavior information from one or more vehicle systems during a drive, wherein the driver behavior information includes the first parameter values associated with the first powertrain control mode; and
updating the user profile based on the first parameter values from the driver behavior information.

18. The non-transitory computer-readable storage medium of claim 16, wherein obtaining the user profile further comprises receiving the user profile from an external service.

19. The non-transitory computer-readable storage medium of claim 16, wherein obtaining the user profile includes transferring the user profile from a first vehicle that does not support the second powertrain control mode to a second vehicle that does support the second powertrain control mode, and controlling the vehicle powertrain is performed using the second vehicle.

20. The non-transitory computer-readable storage medium of claim 16, wherein controlling the vehicle powertrain based on the user profile includes determining whether to activate one of the first powertrain control mode or the second powertrain control mode based on the user profile.
